(19) United States
(12) Patent Application Publication
(10) Pub. No.: US 2013/0032170 A1
(43) Pub. Date: Feb. 7, 2013

(54) Method and Device for Automatically Rinsing Filters, in Particular for Rinsing Glass Fibre Filters in Smoking Machines

(71) Applicants: Martin Blumenstock, Bayreuth (DE); Wolfgang Trinkies, Goldkronach (DE); Robert Nast, Bayreuth (DE); Rasmus Pagh, Bayreuth (DE); Ute Ernst, Mainleus (DE); Heinrich Harald Burghart, Hamburg (DE); Kurt Burghart, Wedel (DE)

(72) Inventors: Martin Blumenstock, Bayreuth (DE); Wolfgang Trinkies, Goldkronach (DE); Robert Nast, Bayreuth (DE); Rasmus Pagh, Bayreuth (DE); Ute Ernst, Mainleus (DE); Heinrich Harald Burghart, Hamburg (DE); Kurt Burghart, Wedel (DE)

(73) Assignee: BRITISH AMERICAN TOBACCO (GERMANY) GMBH, Hamburg (DE)

(21) Appl. No.: 13/566,578

(22) Filed: Aug. 3, 2012

(30) Foreign Application Priority Data
Aug. 3, 2011 (DE) 102011109319.6

(51) Int. Cl. B08B 3/04

(52) U.S. Cl. 134/10; 134/184

(57) ABSTRACT

The disclosure relates to a device for removing filtered substances from combustion processes from a filter under laboratory conditions. In some implementations, this comprises a mount for the filter and a rinsing means for rinsing out the filter in its mount by means of a liquid. It may also relate to a method for removing filtered substances from combustion processes from a mounted filter under laboratory conditions in order to analyse the filtrate, wherein the filter is rinsed out in its mount with a liquid.

### CLAIM FOR PRIORITY

This application is entitled to and hereby claims priority under 35 U.S.C. §§119 to corresponding German Application No. 10 2011 109 319.6 filed on Aug. 3, 2011. The entire contents of the aforementioned application are herein expressly incorporated by reference.

### DETAILED DESCRIPTION

This disclosure relates to a method and device for automatically rinsing filters, in particular for rinsing glass fibre filters (referred to in the following as Cambridge filters), in smoking machines.

Smoking machines are used in laboratories to determine the constituents of cigarette smoke, wherein cigarettes are lit on a machine, draws of a particular volume are automatically taken at particular intervals, and this smoke is drawn through a filter—the Cambridge filter—on which particles of the cigarette smoke collect. In order to be analysed, these particles have to be removed again from the Cambridge filter. In accordance with the relevant standards, the Cambridge filter is then placed inside an Erlenmeyer flask containing a defined amount of a solvent, and the particles which have collected on the Cambridge filter are eluted within a predetermined period of time and so made available for further analysis and quantifying.

One embodiment of the disclosure automates the latter eluting process and arrives at the same result with reduced manual input and within a shorter time period, thereby improving efficiency.

In one embodiment, the disclosure comprises a device configured for removing filtered substances from combustion processes from a filter under laboratory conditions, comprising a mount for the filter and a rinser for rinsing out the filter in the mount using a liquid, wherein the device is assigned to at least one of a smoking product and a cigarette smoking machine. In one implementation the disclosure comprises method for removing filtered substances from combustion processes from a mounted filter under laboratory conditions to analyze filtrate, wherein the filter is rinsed out with a liquid in a device for removing filtered substances from combustion processes from a filter under laboratory conditions, comprising a mount for the filter and a rinser for rinsing out the filter in the mount using a liquid, wherein the device is assigned to at least one of a smoking product and a cigarette smoking machine. Embodiments are further defined and/or clarified in the sub-claims.

In accordance with the disclosure, the device for removing filtered substances from combustion processes from a filter under laboratory conditions comprises a mount for the filter and a rinser or other rinsing means for rinsing out the filter in its mount by means of a liquid. The device is assigned to a smoking product and/or cigarette smoking machine. Depending on the embodiment, the rinser or other rinsing means can be integrated into the mount or can be formed separately.

The filter can be a particle filter of a smoking machine, in particular a smoking product and/or cigarette smoking machine. The liquid can be a solvent, in particular isopropanol.

The mount can be a mount for the filter, in particular a filter holder in a smoking machine, in particular a smoking product and/or cigarette smoking machine. In one embodiment, the mount can comprise a first filter holder part and a second filter holder part. Alternatively, the mount can be formed in one part. The mount can comprise a filter receptacle and a flow region assigned to the filter receptacle, wherein the filter receptacle can be formed as a cavity in the first and/or second filter holder part. The filter receptacle can at least substantially exhibit the shape of a filter. In this way, the filter can be placed on the filter receptacle in a positive fit, at least in sections. The flow region can be formed as a conical cavity in the first and/or second filter holder part.

The mount can comprise a central bore, in particular a central bore comprising a widened portion for receiving a flow device, in particular a pump. The mount can comprise at least one or more solvent conduits (which are in particular connected to each other) which can in particular be in flow communication with the central bore and/or the filter receptacle and/or the flow region. The solvent conduits can be formed as bores in the first and/or second filter holder part.

In accordance with a method in accordance with the current disclosure for removing filtered substances from combustion processes from a mounted filter under laboratory conditions in order to analyse the filtrate, the filter is rinsed out with a liquid in a device for removing filtered substances from combustion processes from a filter under laboratory conditions, comprising a mount for the filter and a rinser for rinsing out the filter in the mount using a liquid, wherein the device is assigned to at least one of a smoking product and a cigarette smoking machine. A solvent can in particular be used as the rinsing liquid.

Using such a method, it is possible to remove the substances from a particle filter of a smoking machine. While being rinsed out, the filter can be mounted in the filter mount of a smoking machine, in particular a smoking product and/or cigarette smoking machine.

In one embodiment of the disclosed method, the filter can be rinsed out with a first amount of liquid in a first rinsing step and rinsed out with a second amount of liquid in a second rinsing step. The filter can in particular be removed from the device between the first rinsing step and the second rinsing step.

In some embodiments, the disclosure can also be defined such that the mount of the filter, in particular the Cambridge filter, is altered such that rinsing with the solvent can be performed directly in the holder.

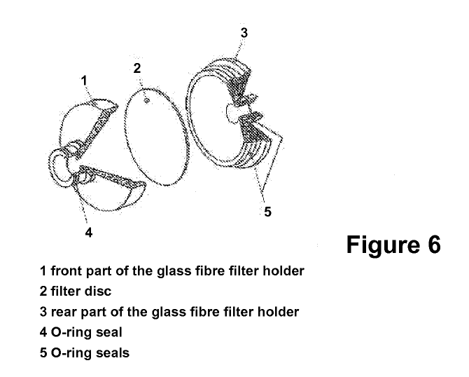

A conventional holder for a Cambridge filter can be seen in FIG. 6 from the relevant DIN ISO 3308 standard.

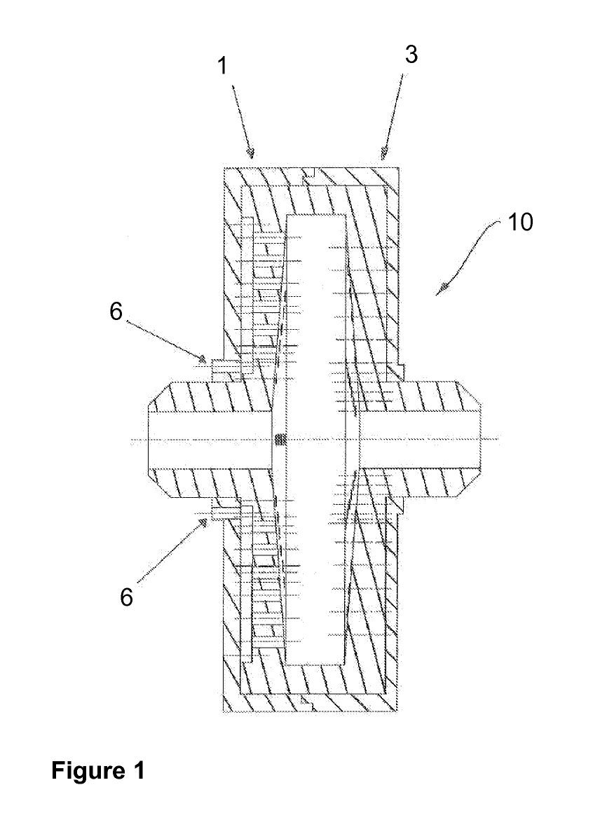

In the following, embodiments of the present disclosure are explained in more detail by referring to the enclosed drawings, wherein FIGS. 1 to 5 each show differently configured filter holder embodiments.

According to a first variant in accordance with the cross-sectional representation in FIG. 1, additional bores 6 can be arranged on one or both parts 1, 3 of the filter holder 10 and the solvent can be introduced through said bores 6, wherein air which is present beforehand escapes and the solvent is then pumped back and forth and flows through the filter in a defined way, wherein the pump is attached to the filter holder.

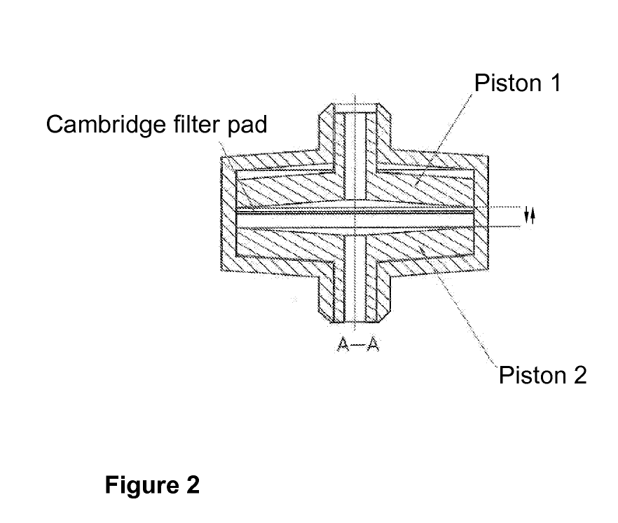

An embodiment in accordance with the schematic cross-sectional representation in FIG. 2 differs from that shown in FIG. 1 in that the solvent is moved by two pistons which are part of the filter holder, wherein the solvent is in particular introduced via the central bore. In alternative embodiments, the solvent can additionally or alternatively be moved by a rotational movement of the filter holder, in particular an additional rotational movement of the filter holder.

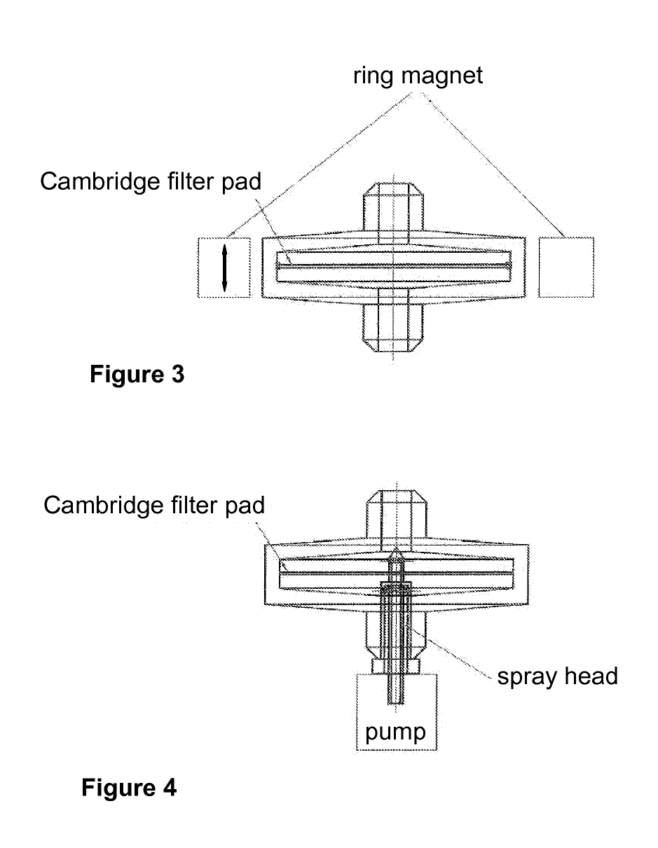

Another implementation in accordance with the cross-sectional representation in FIG. 3 is characterised in that the Cambridge filter is held in a mount which can be magnetised and, once the solvent has been introduced into the hollow space from without, the “stationary” solvent is moved back and forth by a (ring) magnet. A sample embodiment is shown here schematically.

Further embodiments in accordance with the schematic cross-sectional representation in FIG. 4, the Cambridge filter is pierced by a spray head which comprises openings on both sides of the Cambridge filter and can thus introduce solvent on both sides through a pump and recover the solvent on the other side in each case.

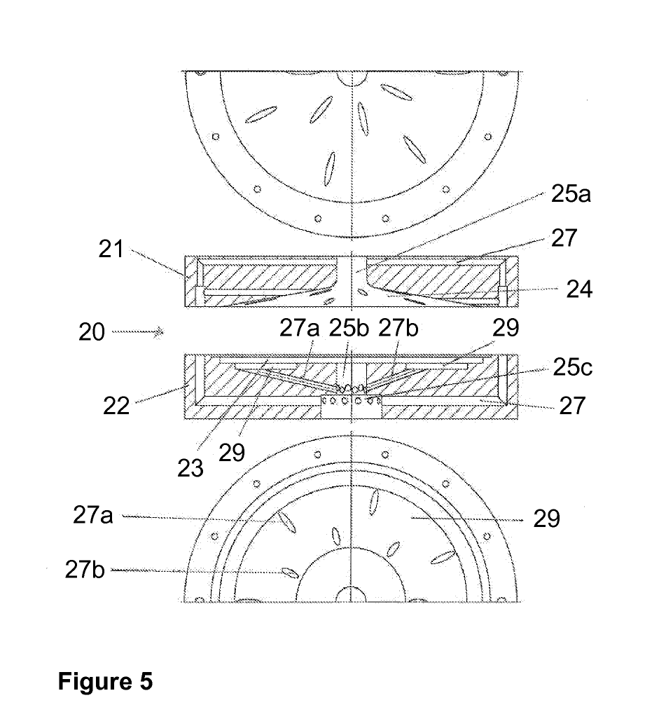

FIG. 5 shows another implementation in a cross-sectional representation and a partial top view. The mount—in this case, the filter holder 20—comprises a first filter holder part 21 and a second filter holder part 22. When they are assembled, the first filter holder part 21 can be in communication with the second filter holder part 22 in a positive fit. A seal (not shown here), in particular a sealing ring, can in particular be arranged between the first filter holder part 21 and the second filter holder part 22.

A filter receptacle 23, in which a Cambridge filter can be arranged, is provided on the second filter holder part 22. The filter receptacle 23 can be formed such that the shape of the filter receptacle 23 corresponds to the shape of the Cambridge filter. A flow region 24 is assigned to the filter receptacle 23. The flow region 24 can be formed, as shown, as a conical cavity in the first filter holder part 21.

The filter holder 20 comprises a central bore 25a, 25b which extends through both the first filter holder part 21 and the second filter holder part 22. In some implementations, both smoke and solvent can be channeled through the central bore 25a, 25b. The central bore 25a, 25b can exhibit the same diameter in the first filter holder part 21 as in the second filter holder part 22, at least in sections. In particular, the central bore 25b of the second filter holder part 22 comprises a widened portion 25c in which a flow device, in particular a pump for conveying a solvent, can be arranged. The central bore 25a, 25b and the flow region 24 are in flow communication with solvent conduits 27.

The solvent conduits 27 can in particular be formed as bores in the first filter holder part 21 and/or in the second filter holder part 22. The solvent conduits 27 can be arranged parallel to the central bore 25a, 25b, at least in sections, and/or can be arranged perpendicular to the central bore 25a, 25b, at least in sections. The solvent conduits 27 can in particular be arranged transverse to the central bore 25a, 25b, at least in sections.

FIG. 5 shows a first solvent conduit portion 27a and a second solvent conduit portion 27b in a cross-sectional representation through the second filter holder part 22. The first solvent conduit portion 27a and the second solvent conduit portion 27b are arranged oppositely in different angular positions in relation to the central bore 25b. The first solvent conduit portion 27a and the second solvent conduit portion 27b extend from the central bore 25b to a feed region 29.

The feed region 29 is in flow communication with the filter receptacle 23. The feed region 29 can be formed, as shown, as an annular cavity which can in particular be arranged immediately beneath the filter receptacle 23.

As can be seen from the partial top view shown in FIG. 5, the second filter holder part 22 comprises a multitude of first solvent conduit portions 27a and second solvent conduit portions 27b which feed into the feed region 29. Because the first solvent conduit portions 27a and the second solvent conduit portions 27b have a different angular position in relation to the central bore 25b, their feed openings are formed as ellipses of different sizes.

When the filter holder 20 is installed in a smoking product smoking machine, smoke can be suctioned through the central bore 25a, 25b in a direction from the first filter holder part 21 to the second filter holder part 22 in a smoking mode, wherein the solvent conduits 27 can be closed by a closing device, for example a valve.

In a rinsing mode of the smoking product smoking machine, the solvent conduits 27 can be opened and filled with a solvent. A pump which is arranged in the widened portion 25c of the central bore 25b can pump the solvent through the solvent conduits 27 and so rinse a filter arranged between the first filter holder part 21 and the second filter holder part 22.

In the rinsing mode, the solvent can be pumped back and forth within the flow region 24. A volume formed by the filter receptacle 23, the flow region 24, the central bore 25a, 25b and the solvent conduits 27 can in particular correspond to a standardised volume.

1. A device for removing filtered substances from combustion processes from a filter under laboratory conditions, comprising a mount for the filter and a rinser for rinsing out the filter in the mount using a liquid, wherein the device is assigned to at least one of a smoking product and a cigarette smoking machine.

2. The device according to claim 1, wherein the filter is a particle filter of a smoking machine, wherein the smoking machine is at least one of the smoking product and the cigarette smoking machine.

3. The device according to claim 1, wherein the mount is for the filter in the smoking machine.

4. The device according to claim 1, wherein the liquid is a solvent.

5. The device according to claim 1, wherein the mount comprises a first filter holder part and a second filter holder part.

6. The device according to claim 1, wherein the mount comprises a filter receptacle and a flow region assigned to the filter receptacle.

7. The device according to claim 1, wherein the mount comprises a central bore, wherein the central bore comprises a widened portion for receiving a flow device, wherein the flow device comprises a pump.

8. The device according to claim 7, wherein the mount comprises at least one solvent conduit, wherein the at least one solvent conduit is in flow communication with at least one of the central bore, the filter receptacle and the flow region.

9. A method for removing filtered substances from combustion processes from a mounted filter under laboratory conditions to analyze filtrate, wherein the filter is rinsed out with a liquid in a device for removing filtered substances from combustion processes from a filter under laboratory conditions, comprising a mount for the filter and a rinser for rinsing out the filter in the mount using a liquid, wherein the device is assigned to at least one of a smoking product and a cigarette smoking machine.

10. The method according to claim 9, wherein the substances are removed from a particle filter of a smoking machine.

11. The method according to claim 9, wherein while being rinsed out, the filter is mounted in the filter mount of a smoking machine, wherein the smoking machine is at least one of a smoking product and cigarette smoking machine.

12. The method according to claim 9, wherein a solvent is used as rinsing liquid.

13. The method according to claim 9, wherein the filter is rinsed out with a first amount of liquid in a first rinsing step and is rinsed out with a second amount of liquid in a second rinsing step.

14. The method according to claim 13, wherein the filter is removed from the device between the first rinsing step and the second rinsing step.
